(19) United States
(12) Patent Application Publication
(10) Pub. No.: US 2008/0014568 A1
(43) Pub. Date: Jan. 17, 2008

(54) Method and apparatus for correlating and aligning educational curriculum goals with learning content, entity standards and underlying precedents

(76) Inventor: Theodore Craig Hilton, Columbus, NC (US)

Correspondence Address: JEFFER, MANGELS, BUTLER & MARMARO, LLP, 1900 AVENUE OF THE STARS, 7TH FLOOR, LOS ANGELES, CA, 90067, US

(21) Appl. No.: 11/800,408

(22) Filed: May 2, 2007

Related U.S. Application Data
(60) Provisional application No. 60/819,911, filed on Jul. 12, 2006.

(51) Int. Cl. G09B 3/00

(52) U.S. Cl. 434/350

(57) ABSTRACT

A process for generating and deploying a real-time automatic independent learning plan (ILP) for a person based on academic curriculum standards. More specifically, an automated process is disclosed that includes as a first step testing and remediation for students to determine the assessment of that student's competency and mastery of certain academic disciplines, followed by the automatic generation, based on such assessment, of an ILP, which is a unique and individualized set of learning content assembled to assist the particular student in learning one or more process standards.

### CLAIM OF PRIORITY UNDER 35 U.S.C. §119

The present Application for Patent claims priority to Provisional Application No. 60/819,911 entitled “Processing for Correlating and Aligning Educational Curriculum Goals with Learning Content and Entity Standards and Underlying Precedents,” filed Jul. 12, 2006, and hereby expressly incorporated by reference herein.

### CLAIM OF PRIORITY UNDER 35 U.S.C. §120

The present Application for Patent is a continuation-in-part of Patent Application No. (to be assigned) entitled “Method and Apparatus for Implementing an Independent Learning Plan (ILP) based on Academic Standards” filed Apr. 18, 2007, pending, and assigned to the assignee hereof and hereby expressly incorporated by reference herein.

### BACKGROUND

1. Field

The present invention relates generally to educational learning systems, and more particularly, to a method and apparatus for correlating and aligning educational curriculum goals with learning content, entity standards and underlying precedents.

2. Background

Heretofore, efforts have been made to interactively assess and evaluate the knowledge levels and competencies of individuals with respect to certain academic disciplines, in order to provide a basis for generating a learning plan specifically tailored to that person's needs or deficiencies. This learning plan, referred to as an independent learning plan (ILP), is a unique and individualized set of curricula and learning content assembled to assist a particular student in learning one or more process (or teaching) standards. A process standard is the lowest measured level of a curriculum standard, which itself is a codified benchmark applied to a specific academic discipline and grade that indicates an acknowledged measure of a fundamental learning principle. Specifically, a benchmark is a process standard defined as a root standard or goal against which other entity standards are applied.

One difficulty in assessing the competency and understanding of a student regarding a specific academic discipline is the various academic or learning standards applied by different states, different school systems or different governmental authorities or administrations. Collectively, these entity standards are a process standard for an entity such as a state or local defining body. Each state has its own sets of academic standards that apply to students, and oftentimes these standards are significantly different from state to state. Thus, although there exist in the art processes that provide various computer-based learning systems and delivery mechanisms, a significant problem in education today is the arbitrary application of curriculum standards by educational entities. Specifically, few entities share content standards, making it difficult to align educational content to more than one entity's standards at a time. Because there is no established curriculum hierarchy, student users do not have the ability to traverse curriculum to determine precedent or underlying concepts upon which current standards are based. This lack of a unifying system or process in curriculum alignment to a traversable model has resulted in an education system built on numerous entity-specific solutions, few of which share commonality.

Further, there exist processes that measure the competency of an individual to create an ILP or “training regimen.” However, existing processes do not utilize a baseline framework of curriculum standards nor unique learning/feedback loops. For example. For children with special learning and educational requirements, an ILP is created by the teacher to focus on the unique needs and requirements of the student. This ILP typically contains a unique collection of all learning materials, such as workbook exercises, web-based learning animations, textbook passages and the like, that apply to the teaching, understanding, and learning of a process standard (all these teaching materials are collectively referred to as learning content). Because of the time constraints and teaching experience necessary to create, implement, deliver, and follow-through with an ILP, they are not generally applied to students without special needs.

One difficulty in assessing a student's academic skills involves the methodology used in making such a determination. Some testing programs simply test a student's basic skills to determine, for instance, whether the student understands multiplication of fractions. The testing procedure might include several fraction multiplication problems, which will indicate whether the student can solve the problem or not. However, such testing is only useful on a pass or fail basis. In other words, such basic testing will illustrate whether the student has mastered the skill or has not, but it will not determine the level of remediation required for the student to ultimately master the skill. Thus, it would be desirable to be able to determine a student's skill level in math, for instance, in such detail that it can identify the specific deficiencies that the student must overcome in order to master the skill. For example, if a student cannot multiply fractions, it should be determined whether the student has mastered multiplication of integers, which is a pre-requisite skill to multiplying fractions.

It would be desirable to address the shortcomings and difficulties noted above.

### SUMMARY OF THE PREFERRED EMBODIMENTS

The present invention provides for a platform that integrates curriculum standards at any level down to the individual classroom with instructional content in a friendly and easy-to-use environment.

In one preferred embodiment of the present invention, the parameters of state or local academic standards, and entity levels (advanced, average, or special needs, for instance) are correlated so that a generated automatic independent learning plan (ILP) is applicable to that particular student. An automated testing and remediation program is provided to assess and evaluate the fundamental and complex skills of a student in a particular academic discipline in such detail that the student's deficiencies are probed sufficiently to determine exactly which fundamental skills must be mastered in order to master the more complex skills appropriate to that student's age, grade level, and entity.

Other features and advantages will become apparent to those skilled in the art from the following detailed description. It is to be understood, however, that the detailed description and specific examples, while indicating exemplary embodiments, are given by way of illustration and not limitation. Many changes and modifications within the scope of the following description may be made without departing from the spirit thereof, and the description should be understood to include all such variations.

### BRIEF DESCRIPTION OF THE DRAWINGS

The invention may be more readily understood by referring to the accompanying drawings in which:

FIG. 1 is a block diagram of a correlation and alignment system configured in accordance with one preferred embodiment of the present invention;

FIG. 2 is a correlation and alignment system configured in accordance with one preferred embodiment of the present invention; and,

FIG. 3 is a flow diagram of an alignment and correlation process that is configured in accordance with one preferred embodiment of the present invention;

FIG. 4 is a diagram of a nested-set matrix configured in accordance with one preferred embodiment of the present invention;

FIG. 5 is a block diagram of the major dimensions of the matrix interrelating as configured in accordance with one preferred embodiment of the present invention; and,

FIG. 6 is a block diagram of a computer system configured in accordance with one preferred embodiment of the present invention.

Like numerals refer to like parts throughout the several views of the drawings.

### DETAILED DESCRIPTION OF THE PREFERRED EMBODIMENTS

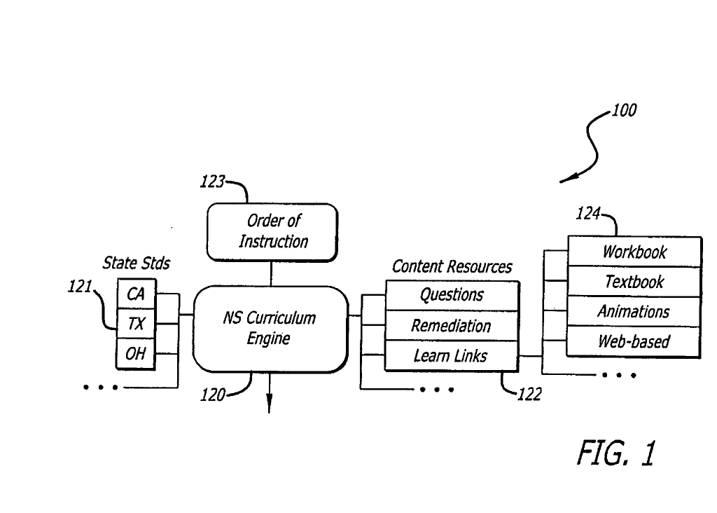

FIG. 1 illustrates a system 100 that generates and dynamically maintains a central hierarchal alignment of a process standard (e.g., a “benchmark”) to a wide range of associations that include but are not limited to:

a) any entity-specific (e.g., a state such as California, Texas, or Ohio) standard(s) 121 in any format,

b) an intrinsic order of instruction 123 of precedent or underlying concepts, where the order of instruction 123 defines each underlying precedent, process or concept that must be understood or comprehended by a student prior to understanding a benchmark,

c) various learning content 124 in any format (“Learn*Links”),

d) questions and assessment material 122 in any format, and

e) remediation 122 in any format.

A curriculum engine 120 provides implicit correlation and alignment for each of these associations.

Current art for the alignment of learning content to curriculum standards is usually determined by way of either:

a) automatic serial parsing of the underlying language,

b) database structures, or

c) manual alignment by content experts.

Generally, these alignment processes are cumbersome and prone to inaccuracies. In one preferred embodiment of the present invention, these problems are addressed by a unique nested-set alignment algorithm.

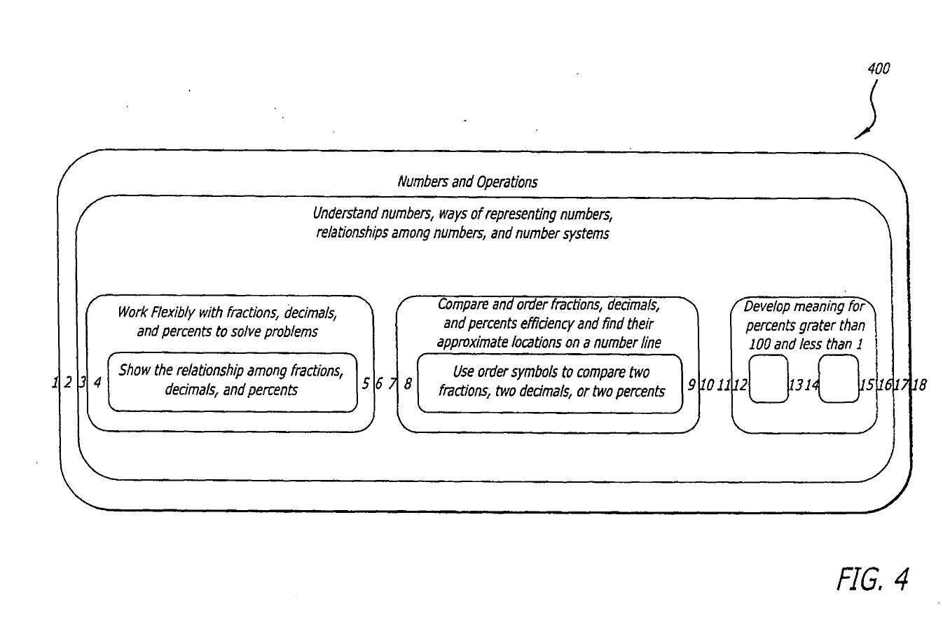

In one preferred embodiment of the present invention, a process of alignment and correlation is followed that provides each benchmark a dynamic yet totally hierarchal position against which associations are performed. In step 302, a benchmark is aligned to applicable learning content in a nested-set matrix. An example of a nested-set matrix 400 is shown in FIG. 4. Then, in step 304, the benchmark is correlated to each of the underlying precedent and underlying element(s) into their respective order of instruction. Then, in step 306, entity relationships are correlated to the resultant tuple, yielding a process that fully and comprehensively presents any type of entity standards applied to any type of learning content while preserving an easy to traverse order of instruction.

In one preferred embodiment of the present invention, the correlation of entity standards is defined to the baseline benchmarks using a unique nested-set algorithm and caching relationship, which requires no pre-defined relationship. The baseline correlation is performed using a many-to-many data representation model. An order of learning is then determined and integrated into each benchmark object model in a one-to-many data representation. This integration of the entity-correlation and the order of learning correlation results in a benchmark platform that can be represented using any number of data storage models, including: a) relational, b) object, c) array or d) printed. This benchmark platform is then correlated to individual learning content resulting in a nested-set structure that intrinsically accommodates and supports a wide variety of entity standards, learning styles, and content types.

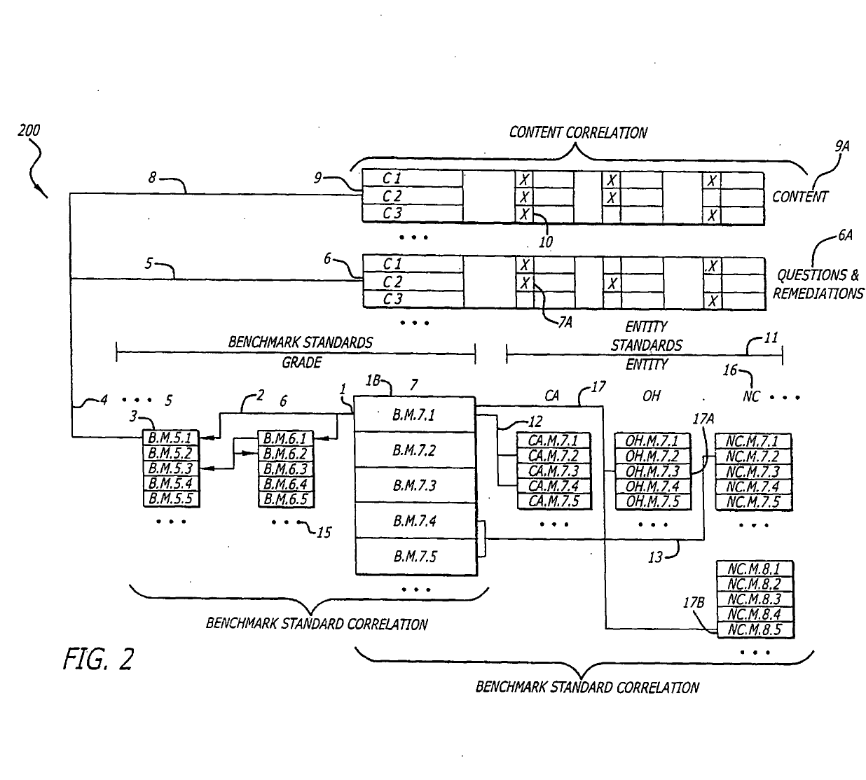

In one preferred embodiment of the present invention, FIG. 2 reflects a grade-based grouping of benchmark and entity standards. Implicit in this model is the ability to represent benchmarks and entities by any arbitrary grouping, one such grouping being “Grade”.

For purposes of describing FIG. 2, the following naming nomenclature as applied to benchmark and entity standards will be used:
B=Benchmark or entity level
M=Mathematics (or other arbitrary grouping)
7=Grade (or other arbitrary grouping)

Thus, “B.M.7.1” is defined as “Benchmark-level+Mathematics+Grade 7+Number 1”. Similarly, “NC.M.4.2” is defined as “NC-level+Mathematics+Grade 4+Number 2”.

The “. . . ” symbol indicates that the displayed set continues onward, though not displayed, until finished

Continuing to refer to FIG. 2:

Block 1C indicates that these 3 individual grouping of standards beneath this grouping indicator are all “Benchmark Standards” for the Grades represented just above each individual group

Block 1 represents a group of 5 Benchmark standards for Mathematics Grade 7 (1-5 inclusive). An example of one of these Benchmark standards might be “student will understand multiplication of fractions”.

Block 15 represents that this group continues on, though not shown, until all benchmarks for this discipline and grade are displayed

Block 1B represents Grade “7”.

Groups of benchmark standards are represented to the left of the Grade 7 Benchmark, representing grades 6 and 5 respectively. Of course, other grades would be similarly applicable, as suggested by the “. . . ”. Each of the respective Benchmarks (i.e., that for Grade 6) represents the same notation as that of Grade 7 Benchmarks.

Each Benchmark has one or more precedent or underlying concepts that must be understood to master that benchmark. These precedents are referred to as the benchmark's “order of instruction”.

Block 2 represents the order of instruction from B.M.7.1 to its precedent benchmarks B.M.6.1 and B.M.5.1. Similarly, the order of instruction from B.M.6.1 are B.M.6.2 and B.M.5.3. Of course, these are representative only, and there may be one or more underlying concepts associated with each benchmark.

In one preferred embodiment of the present invention, every benchmark can have content associated with it. Content includes, but is not limited to, such educational materials as textbook pages, workbook pages, interactive sites, animations, questions, remediation and the like.

Block 3 represents 2 arbitrary types of content associated with a particular benchmark—in this case B.M.5.1.

Block 5 represents all questions+remediation associated with B.M.5.1. This can be a value of from zero to an unlimited number of questions. In one preferred embodiment of the present invention, every question has associated with it a single remediation.

Block 8 represents all content associated with B.M.5.1. This can be a value of from zero to an unlimited number of learning content items.

Block 6 represents individual questions+remediation.

Blocks 7 and 7A show how each individual question+remediation can be individually selected for inclusion in each entity set. Thus, each entity can determine each of those questions+remediation couples that are applicable to that entity. This allows the precise tuning of questions to specific entities and the refining of metric measures. For example, block 7A shows that Q.1 and Q.2 are applicable for the entity of “CA”.

Block 9 represents individual learning content.

Block 10 shows how each individual learning content item can be individually selected for inclusion for each entity set—as set forth in blocks 7 and 7A. For example, block 10 shows that C.1 and C.2 and C3 are applicable for the entity of “CA”.

As shown in block 11, each benchmark can be correlated to an arbitrarily long set of entities. An entity can be, for example, a state set of curriculum standards, a organization set of standards, a local set of standards for a particular group of students, or even a set of standards for a single student. A many-to-many data representation reflects the relationship of a benchmark to an entity standard.

Block 12 represents a group of entity standards. An entity may be of any format or definition, and is not required to fix any definition whatsoever. For example, the entity “CA” has 5 entity standards with the “. . . ” indicating more not shown. Thus, the Benchmark B.M.7.1 is correlated to 2 entity “CA” standards CA.M.7.2 and CA.M.7.5 (one-to-many).

Similarly, benchmark B.M.7.1 is also correlated to 1 entity “OH” standard OH.M.7.3 and entity “NC” standard NC.M.6.5 (one-to-many).

Likewise, benchmark B.M.7.4 and B.M.7.5 are correlated to the single entity “NC” standard NC.M.7.2 (many-to-one).

This invention allows the implicit generation of a aligned entity standards that apply in a many-to-many data relationship to benchmarks with order of instruction correlation implicitly defined in each benchmark, following alignment of learning content to the benchmark focus. This unique multi-step alignment generates a robust nested-set that provides complete learning drill-down for every entity, including applicable learning content at any curriculum hierarchal level.

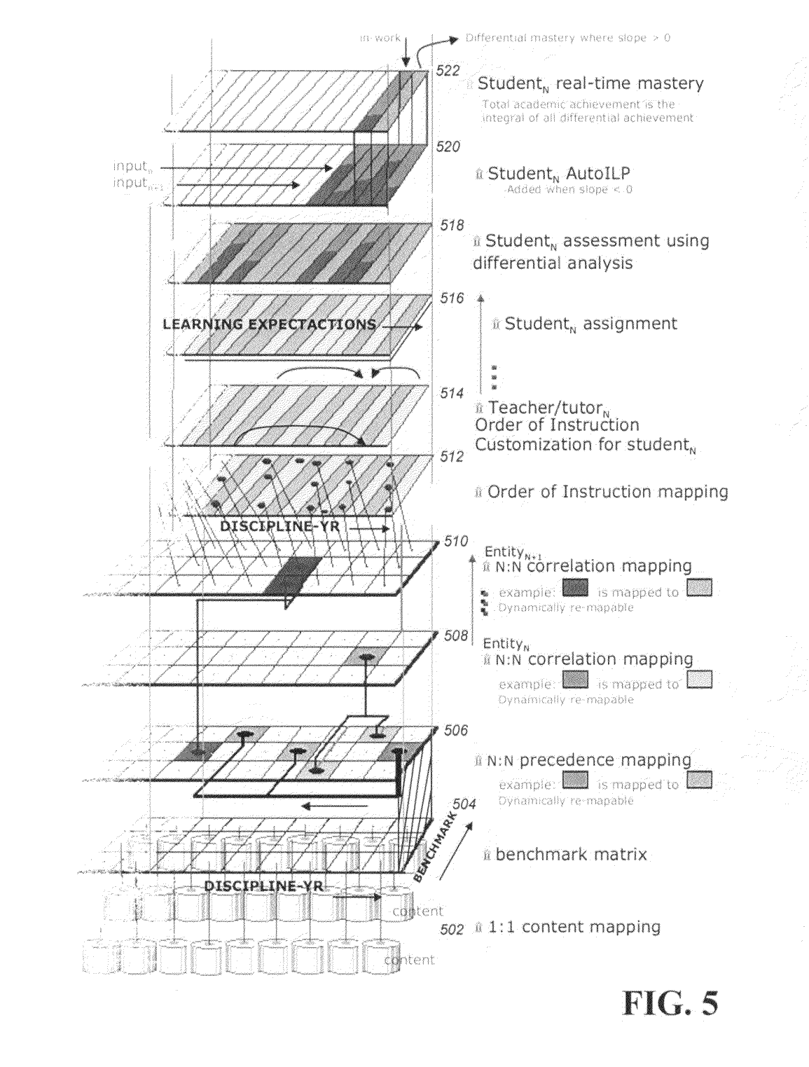

FIG. 5 illustrates how the various mappings and dimensions of the matrix interrelate as configured in one preferred embodiment of the present invention, wherein there is a one-to-one (1:1) mapping of content 502 to a benchmark matrix 504. A precedence mapping 506 can be a N:N mapping. One or more correlation mappings 508, 510 can also be a N:N mapping. An order of instruction mapping 512 follows the correlation mapping, which can be altered by one or more teachers/tutors to create a customized order of instruction mapping 514. A student will then learn using the specific mapping 516, which is then assessed based on differential analysis 518. The specific student's AutoILP 520 will be updated as necessary until the student has achieved mastery in 522.

Once the correlation can be made, an automatic ILP can be created and implemented. An exemplary process for generating and deploying a real-time automatic ILP for a person based on academic curriculum standards is described in co-pending U.S. patent application Ser. No. (to be assigned), entitled “Method and Apparatus for Implementing an Independent Learning Plan (ILP) based on Academic Standard” and filed on Apr. 18, 2000. More specifically, the process is an automated process that includes as a first step of testing and remediation for students to determine the assessment of that student's competency and mastery of certain academic disciplines, followed by the automatic generation, based on such assessment, of an ILP, which is a unique and individualized set of learning content assembled to assist the particular student in learning one or more process standards.

In one preferred embodiment of the present invention, an ILP may be thought of as a curriculum comprising a linear progression of skills, like building blocks, that are used to teach a student any academic skill. In math, for instance, a student must learn to count, to understand the concept of integers, and to perform basic addition and subtraction before moving on to more complex mathematical problems and calculations. In one preferred embodiment of the present invention, students are assigned to various categories, or entities, such as advanced, average or special needs. Any number of entities may be employed, but for the sake of simplicity, the three aforementioned entities will be discussed herein. In addition, a specific ILP may be used for each entity. For instance, if an advanced student must master 10,000 skills in order to graduate from high school, an ILP for an advanced student will endeavor to teach all 10,000 skills to that student prior to high school graduation. Similarly, if an average student must master 5,000 skills in order to graduate from high school, and a special needs student must master 3,000 skills in order to graduate from high school, then ILPs for those students would endeavor to teach only the requisite number of skills necessary for them to graduate.

Because the ILP may be thought of as a linear progression of skills, in one embodiment of the present invention the object of any testing program is to determine where along the linear progression any particular student falls. As a result of such testing, the student's academic skill level has been determined, and then a curriculum for that student may be developed accordingly. The academic skill level of a particular student may be viewed in terms of overall academic knowledge, or may be viewed through the prism of academic standards imposed by the school system or governmental entity, such as a state or local school system, or may be further viewed in terms of the student's academic entity (level) assigned by the state or local school, such as advanced, average, or special needs.

Regardless of the academic standards and entities imposed by the different educational authorities, the ILP is still a linear progression of skills, each of which must be learned in a particular order before moving to the next, more complex skill. Through testing, it would be desirable to determine not only which complex skills may not have been mastered by the student, but also which underlying basic skills that student may not have mastered, which would account for that student's failure to grasp more complex skill.

In one preferred embodiment of the present invention, the system provides every participating student, regardless of academic need or assessment, the process of determining a student's competency and mastery of a process, standard (or teaching standard) level, which is the lowest measurable level of a curriculum standard, a unique and completely personalized automatic ILP (AutoILP) as well as the process for implementing, delivering, feedback and follow-through with the AutoILP. The AutoILP is a self-instruction model that, among other attributes, allows a teacher/tutor to tailor assignment delivery in combinations of macro (i.e., entire class) or micro (i.e., single student) delivery, based solely on the requirements of the specific entity.

In one preferred embodiment, the AutoILP is created based on a unique correlation of:

1) curriculum standards, which is a codified benchmark applied to a specific academic discipline that is a subject studied within an educational environment such as mathematics or language arts, and a grade that indicates an acknowledged measure of a fundamental learning principle;

2) learning content, which is a collection of all learning materials such as workbook exercises, web-based learning animations, textbook passages and the like, that apply to the teaching, understanding, and learning of a process standard;

3) test questions, which are questions with measurable answers that can be correlated to the accurate assessment of a particular process standard; and,

4) remediation, which is the explanation of how a correct answer is obtained to a specific test question, using a learning/feedback loop to constantly assess the progress of every student at every point along the AutoILP.

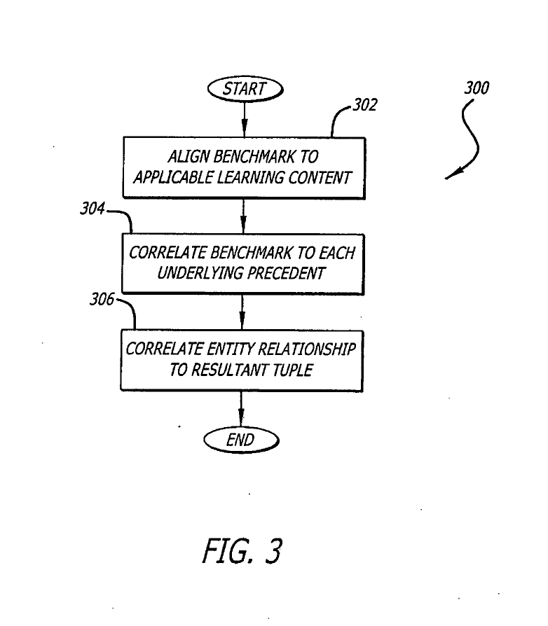

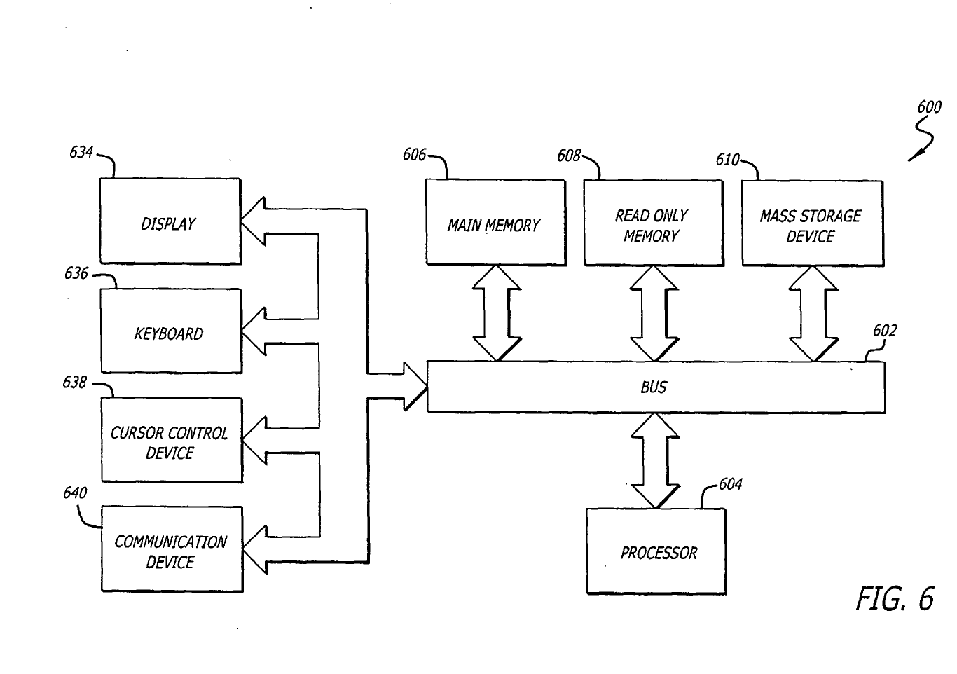

FIG. 6 illustrates an example of a computer system 600 in which the features of the present invention may be implemented. The computer system 600 includes a bus 602 for communicating information between the components in the computer system 600, and a processor 604 coupled with the bus 602 for executing software code, or instructions, and processing information. The computer system 600 further comprises a main memory 606, which may be implemented using random access memory (RAM) and/or other random memory storage device, coupled to the bus 602 for storing information and instructions to be executed by the processor 604, such as information and instructions necessary to implement the process described in FIG. 3. The main memory 606 also may be used for storing temporary variables or other intermediate information during execution of instructions by the processor 604. The computer system 600 also includes a read only memory (ROM) 608 and/or other static storage device coupled to the bus 602 for storing static information and instructions for the processor 604.

A communication device 640 is also coupled to the bus 602 for accessing other computer systems, as described below. The communication device 640 may include a modem, a network interface card, or other well-known interface devices, such as those used for interfacing with Ethernet, Token-ring, or other types of networks. In this manner, the computer system 600 may be coupled to a number of other computer systems.

A mass storage device 610, such as a magnetic disk drive and/or a optical disk drive, may be coupled to the computer system 600 for storing information and instructions. The computer system 600 can also be coupled via the bus 602 to a display device 634, such as a cathode ray tube (CRT) or a liquid crystal display (LCD), for displaying information to a user (e.g., student) so that, for example, graphical or textual information may be presented to the user on the display device 634. Typically, an alphanumeric input device 636, including alphanumeric and other keys, is coupled to the bus 602 for communicating information and/or user commands to the processor 604. Another type of user input device shown in the figure is a cursor control device 638, such as a conventional mouse, touch mouse, trackball, track pad or other type of cursor direction key for communicating direction information and command selection to the processor 604 and for controlling movement of a cursor on the display 634. Various types of input devices, including, but not limited to, the input devices described herein unless otherwise noted, allow the user to provide command or input to the computer system 600. For example, in the various descriptions contained herein, reference may be made to a user “selecting,” “clicking,” or “inputting,” and any grammatical variations thereof, one or more items in a user interface. These should be understood to mean that the user is using one or more input devices to accomplish the input. Although not illustrated, the computer system 600 may optionally include such devices as a video camera, speakers, a sound card, or many other conventional computer peripheral options.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium is coupled to the processor, such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The embodiments described above are exemplary embodiments. Those skilled in the art may now make numerous uses of, and departures from, the above-described embodiments without departing from the inventive concepts disclosed herein. Various modifications to these embodiments may be readily apparent to those skilled in the art, and the generic principles defined herein may be applied to other embodiments without departing from the spirit or scope of the novel aspects described herein. Thus, the scope of the invention is not intended to be limited to the embodiments shown herein but is to be accorded the widest scope consistent with the principles and novel features disclosed herein. The word “exemplary” is used exclusively herein to mean “serving as an example, instance, or illustration.” Any embodiment described herein as “exemplary” is not necessarily to be construed as the most preferred or advantageous over other embodiments. Accordingly, the present invention is to be defined solely by the scope of the following claims.

What is claimed is:

1. A multi-dimensional matrix utilizing an integer-based vector that accommodates the implicit correlation of benchmarks (objectives) from any number of related entities to a baseline standard (set) to automatic precedence mapping of all members of the set such that pre-requisites from any given objective are inherent in the set view.
